(19) United States
(12) Patent Application Publication
(10) Pub. No.: US 2024/0157292 A1
(43) Pub. Date: May 16, 2024

(54) CARBON OXIDIZER, CARBON BURNER APPARATUS FOR USE WITH SAME, AND ASSOCIATED MERCURY RECOVERY METHOD

(71) Applicant: Just Refiners (USA) Inc., Sparks, NV (US)

(72) Inventor: Hendrik Lourens Jacob Boekhoud, Sparks, NV (US)

(21) Appl. No.: 18/501,661

(22) Filed: Nov. 3, 2023

Related U.S. Application Data
(60) Provisional application No. 63/424,810, filed on Nov. 11, 2022.

(51) Int. Cl. B01D 53/64; B01D 53/18; B01D 53/78; C22B 43/00; F23G 7/00; F23J 15/06

(52) U.S. Cl. CPC B01D 53/64; B01D 53/18; B01D 53/78; C22B 43/00; F23G 7/00; F23J 15/06; B01D 2252/103; B01D 2257/602; F23G 2206/20

(57) ABSTRACT

A carbon oxidizer includes a carbon burner apparatus, a cyclone, a heat exchanger, and a venturi zinc scrubber. The carbon burner apparatus is configured to oxidize carbon such that mercury is vaporized from the carbon when the carbon is oxidized. The cyclone is fluidly coupled to the carbon burner apparatus and is configured to receive the oxidized carbon from the carbon burner apparatus. The heat exchanger is fluidly coupled to the cyclone and is configured to reduce a temperature of the vaporized mercury. The venturi zinc scrubber is fluidly coupled to the heat exchanger and is configured to receive the vaporized mercury from the heat exchanger.

### 1. CROSS REFERENCE TO RELATED APPLICATION

This application claims priority to U.S. Provisional Patent Application Ser. No. 63/424,810, filed Nov. 11, 2022, the contents of which are incorporated herein by reference in their entirety.

### 2. FIELD OF THE INVENTION

The present invention is directed to carbon oxidizers. The present invention is also directed to methods of recovering mercury with carbon oxidizers.

### 3. BACKGROUND OF THE INVENTION

It is desirable to capture mercury from carbon burner apparatuses, and also to operate carbon burner apparatuses at controlled temperatures. However, known systems are deficient in their ability to capture mercury and/or their ability to operate at controlled temperatures. Such systems may simply oxidize spent carbon and not recover mercury in a controlled manner, and also may operate at uncontrolled temperatures.

It is with respect to these and other drawbacks in the art that the present disclosure is concerned.

### SUMMARY

One aspect of the invention is directed to a carbon oxidizer. The carbon oxidizer includes a carbon burner apparatus, a cyclone, a heat exchanger, and a venturi zinc scrubber. The carbon burner apparatus is configured to oxidize carbon such that mercury is vaporized from the carbon when the carbon is oxidized. The cyclone is fluidly coupled to the carbon burner apparatus and is configured to receive the oxidized carbon from the carbon burner apparatus. The heat exchanger is fluidly coupled to the cyclone and is configured to reduce a temperature of the vaporized mercury. The venturi zinc scrubber is fluidly coupled to the heat exchanger and is configured to receive the vaporized mercury from the heat exchanger.

Another aspect of the invention is directed to a carbon burner apparatus for the aforementioned carbon oxidizer.

Another aspect of the invention is directed to a method of recovering mercury with the aforementioned carbon oxidizer.

Further objects, features, and advantages of the present invention over the prior art will become apparent from the detailed description of the drawings which follows, when considered with the attached figures.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A and FIG. 1B show schematic and isometric views, respectively, of a carbon oxidizer, in accordance with one non-limiting embodiment of the disclosed concept.

FIG. 1C shows an isometric view of a portion of the carbon oxidizer of FIG. 1B.

FIG. 2 and FIG. 3 show isometric views of different portions of a carbon burner apparatus for the carbon oxidizer of FIG. 1A, FIG. 1B and FIG. 1C.

FIG. 4 shows a simplified view of another carbon oxidizer, in accordance with another non-limiting embodiment of the disclosed concept.

FIG. 5 shows a flow chart corresponding to an example method of recovering mercury with a carbon oxidizer.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As employed herein, the term “coupled” shall mean connected together either directly or via one or more intermediate parts or components.

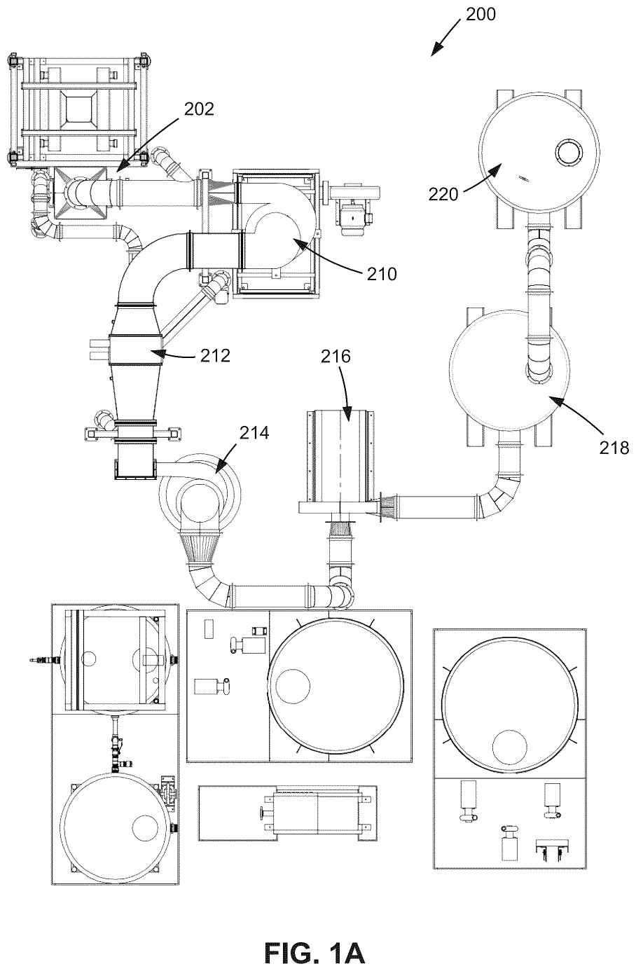

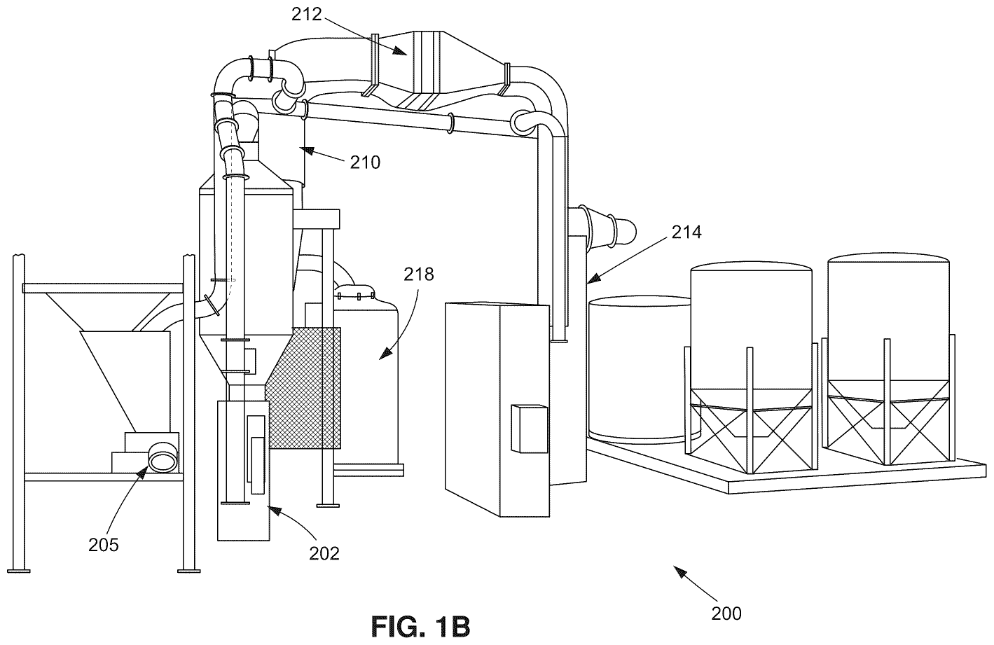

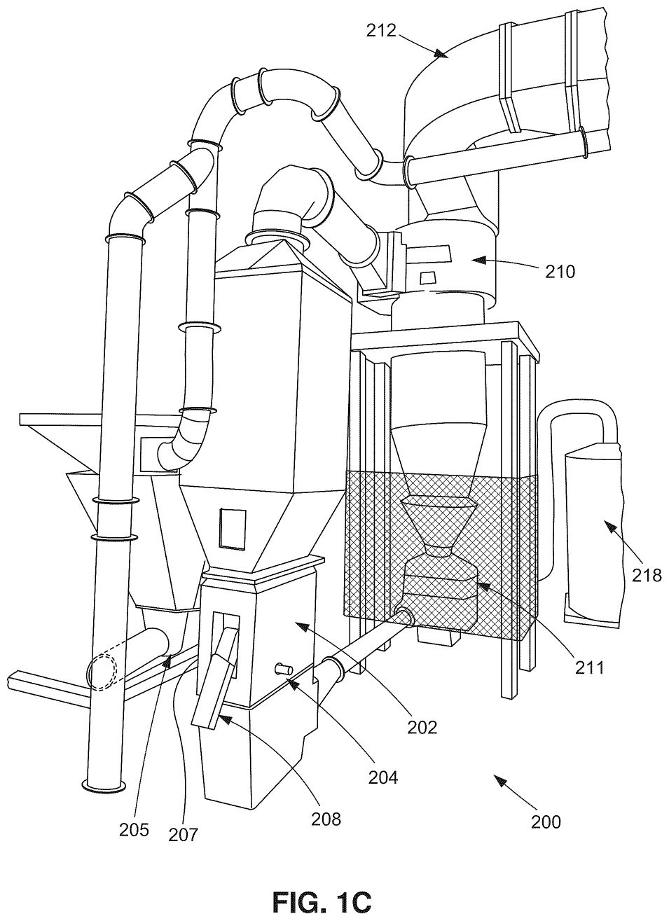

FIG. 1A is a schematic view of a carbon oxidizer 200, and FIGS. 1B and 1C are other views of the carbon oxidizer 200 and a portion of the carbon oxidizer 200, respectively, in accordance with one non-limiting embodiment of the disclosed concept. The carbon oxidizer 200 oxidizes carbon, vaporizes and captures (e.g., recovers in a controlled manner) mercury from the carbon, and recovers precious metal ash for melting. The carbon oxidizer 200 includes a carbon burner apparatus 202 that is configured to burn and oxidize the carbon in order to reduce the carbon mass by approximately 80% for precious metal recovery. The carbon may be fed into the carbon burner apparatus 202 in bulk bags that are hoisted by a crane and trolly to a bag dump station. The carbon burner apparatus 202 is a fluidized bed incinerator that burns the carbon as it enters, e.g., via a feeder portion 205 of the carbon oxidizer 200, the carbon burner apparatus 202, thereby leaving a non-combustible ash behind. The temperature in the bed may be managed by three components: 1) natural gas; 2) air flow; and 3) carbon feed rate, which all function independent of one another. It will be appreciated that the heavier fraction of ash stays in the bed of the carbon burner apparatus 202 to serve as a heat sink and temperature moderator. Furthermore, lighter ash is preferably carried out with the exhaust gas. Once the carbon is burning in the carbon burner apparatus 202, there is advantageously no need to introduce heat.

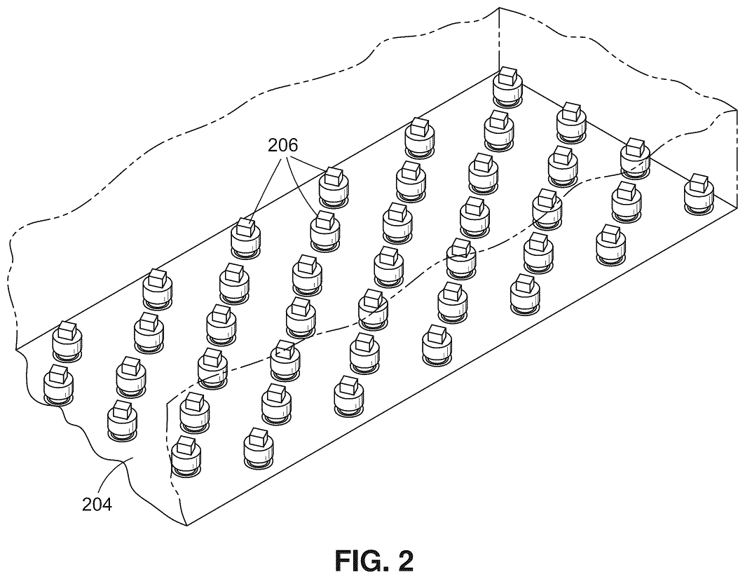

More specifically, in one example embodiment, the oxidation rate of the carbon burner apparatus 202 is monitored by increasing or decreasing the airflow introduced into the carbon burner apparatus 202. See, for example, FIG. 2, which shows a bed plate 204 (also indicated in FIG. 1C) and associated plurality of nozzles (e.g., without limitation, tuyeres 206) of the carbon burner apparatus 202 that are coupled to the bed plate 204 and configured to supply air to the carbon being oxidized. Known prior art carbon burners (not shown) have bed plates with holes in them (e.g., no nozzles or similar apparatus extending therethrough or otherwise coupled thereto). As such, in these prior art burners, the holes undesirably get blocked up such that there is no air moving therethrough, and carbon undesirably remains unburnt in these regions. The disclosed concept is different and is an improvement in this regard.

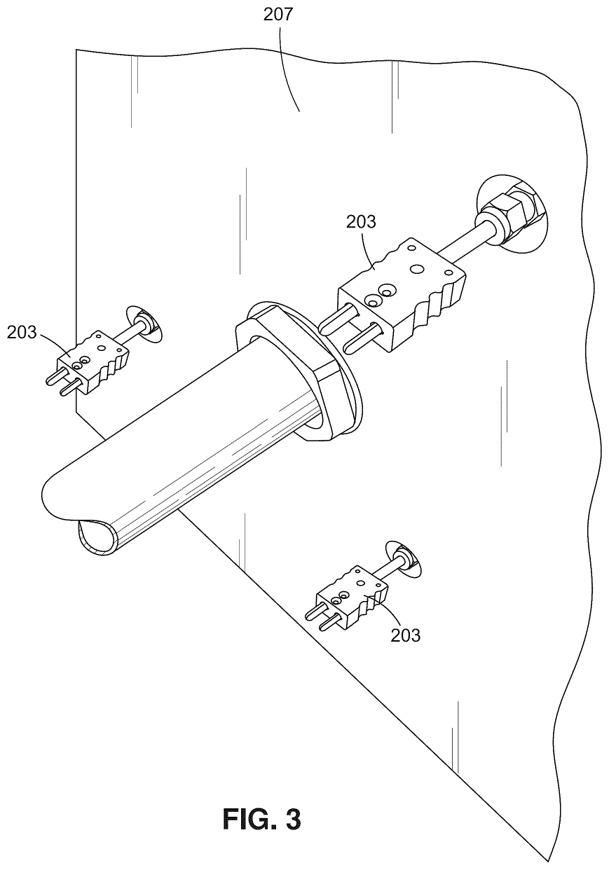

More specifically, once the carbon is ignited, airflow (e.g., ambient airflow) provided through the tuyeres 206 is applied to the carbon for fluidizing purposes. This airflow may be controlled via thermocouples, thermostats, air pressure probes, monitors, and electrical control panels, for instance. In one example embodiment, as shown in FIG. 3, the carbon burner apparatus 202 further includes a wall (e.g., feed side wall 207 of a combustion chamber of the carbon burner apparatus 202) and a plurality of thermocouples 203 coupled to the wall 207, for controlling/monitoring the temperature of the air in the combustion chamber. The wall 207 is preferably coupled to the bed plate 204 (see FIG. 1C), and in one example the wall 207, the bed plate 204, and other walls together define the combustion chamber (e.g., an interior portion of the carbon burner apparatus 202, with respect to reference numeral 202 in FIG. 1C). In one example, the thermocouples 203 are submerged in the wall 207 of the carbon burner apparatus 203. If the thermocouples 203 register a given temperature at a given location of the combustion chamber of the carbon burner apparatus 202, air flow can be increased or decreased through the tuyeres 206 accordingly.

More specifically, responsive to a first thermocouple 203 of the plurality of thermocouples registering a first temperature at a first location of the combustion chamber, air flow may be increased through a first tuyere 206 of the plurality of tuyeres in order to adjust the first temperature, and in turn, responsive to a second thermocouple 203 of the plurality of thermocouples registering a second temperature at a second, different location of the combustion chamber, air flow may be decreased through a second tuyere 206 of the plurality of tuyeres in order to adjust the second temperature. Stated differently, the thermocouples 203 may measure the heat in various compartments of the carbon burner apparatus 202 such that the carbon rate or air volume will be increased if there is too little heat. The result is that the carbon burner apparatus 202 is more efficiently run than prior art carbon burner apparatuses (not shown).

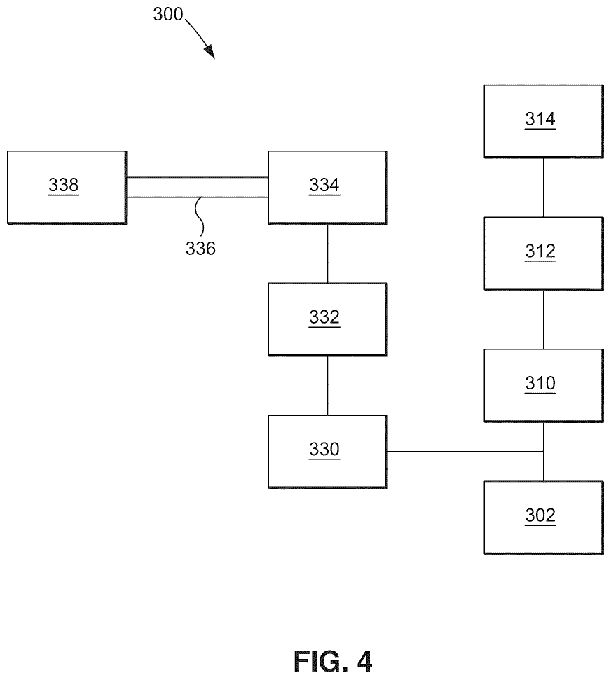

Additionally, it will be appreciated that precious metals may remain with ash from the incinerated carbon. Moreover, in one example embodiment, oxidizing the spent carbon will generate energy in order to boil water. For example, spent carbon from the mining industry may be made from coconut shells, which are relatively hard (e.g., the hardest carbon on the market). This spent carbon may be deliberately hard in order to deal with the attrition of the Carbon in Pulp (CIP) mining operation. Such carbon has incredibly large amounts of energy. The heat generated from burning this spent carbon safely will in turn be incredibly large. As such, the carbon oxidizer 200 may include a heat exchanger for boiling water. This can be appreciated with reference to FIG. 4.

As shown in FIG. 4, which shows an alternative carbon oxidizer 300, which is similar to the carbon oxidizer 200, depicted in FIGS. 1A-1C, and wherein like numbers represent like features (e.g., carbon burner apparatus 302, cyclone 310, heat exchanger 312, venturi zinc scrubber 314). As shown, the carbon oxidizer 300 further includes a second heat exchanger 330 fluidly coupled to each of the carbon burner apparatus 302 and the cyclone 310, a boiler 332 fluidly coupled to the second heat exchanger 330, a steam generator 334 fluidly coupled to the boiler 332, and a conduit 336 fluidly coupled to the steam generator 334 and configured to direct water from a water source 338 into the steam generator 334. In one example, the boiler 332 is configured to be heated by gases passing from the carbon burner apparatus 302 through the second heat exchanger 330 and into the boiler 332. Furthermore, the boiler 332 is configured to heat the water being directed into the steam generator 334 from the water source 338 in order to generate steam (e.g., without limitation, for powering a turbine or for other electrical power use).

Referring again to FIG. 1C, in one example the carbon burner apparatus 202 further includes an overflow chute 208 coupled to the bed plate 204 (e.g., also shown in FIGS. 2 and 3) and configured to receive overflow carbon ash therethrough such that the overflow carbon ash exits the carbon oxidizer 200 for manual re-circulation back into the carbon oxidizer 200. Accordingly, the overflow chute 208 provides a mechanism for oversized carbon to cool down and then be manually re-introduced into the feed hopper.

For example, not all carbon may be incinerated in the carbon burner apparatus 202 in a first pass. By having the overflow chute 208, oversized carbon can advantageously be manually re-introduced and burned, thereby ensuring that substantially all of the carbon is incinerated. As an additional benefit, the carbon burner apparatus 202 may be operated at controlled and lower temperatures, as compared to the prior art. For example, prior art burners are required to incinerate all of the carbon in a first pass, including oversized carbon. In accordance with the disclosed concept, carbon particle sizes are reduced in order to ensure equal and efficient combustion. In other words, the carbon oxidizer 200 operates by addressing and separating oversized carbon particles. As a result, the carbon burner apparatus 202 is configured to operate at lower temperatures, as compared to prior art carbon burner apparatus (not shown), since not all of the carbon is required to be incinerated on the first pass.

In one example embodiment, when the carbon is heated/oxidized in the carbon burner apparatus 202, mercury is removed (e.g., vaporized) from the carbon. In accordance with the disclosed concept, the carbon oxidizer 200 provides a novel and clean manner in which this mercury may be recovered. For example, when the carbon is heated in the carbon burner apparatus 202, an off gas is created, and passes through a cyclone 210 that is fluidly coupled to the carbon burner apparatus 202, in order to receive and slow the velocity of the gas (e.g., the oxidized carbon and vaporized mercury). Additionally, the off gases pass through the cyclone 210 at a temperature of between 1100 and 1300 degrees Celsius, preferably between 1175 and 1225 degrees Celsius, most preferably about 1200 degrees Celsius. By slowing the velocity of the oxidized carbon and the vaporized mercury in the cyclone 210, other solid products (e.g., precious metals such as gold and silver ash) separate from the vaporized mercury. The ash, which contains the gold and silver, may be recovered in a material discharge unit 211 (FIG. 1C) of the cyclone 210, and then melted into bullion bars with arc furnaces. The lighter ash from the carbon burner apparatus 202 is therefore captured in the cyclone 210, while the temperature is kept high enough in order to ensure that the mercury vapor does not drop out with the precious metal ash.

Immediately after the cyclone, the vaporized mercury from the carbon burner apparatus 202 is configured to exit and pass directly into a heat exchanger 212 of the carbon oxidizer 200, which is fluidly coupled to the cyclone 210 and configured to reduce a temperature of the vaporized mercury. In the heat exchanger 212, the air is cooled to less than 250 degrees Fahrenheit. The gas cooling in the heat exchanger 212 requires cooling water to remove the heat from the exhaust gas. The cooling water may be supplied by an external cooling tower, where the water is cooled by evaporative cooling. It will be appreciated that city provided water generated from drying the carbon may be used in order to provide cold water to the heat exchanger 212. Furthermore, softened water may then be supplied in order to maintain the cooling water level. A small amount of water may be removed to limit the dissolved solids concentration, and then combined with blowdown from a venturi zinc scrubber 214 and sent to disposal.

After passing into the heat exchanger 212, the vaporized mercury and the air exit and pass directly into the venturi zinc scrubber 214 with an associated zinc mixing tank and water tanks, wherein the venturi zinc scrubber 214 is fluidly coupled to the heat exchanger 212 and is configured to receive the vaporized mercury. It will be appreciated that scrubbing the off-gases generated by the carbon burner apparatus 202 advantageously ensures that there will be zero deleterious elements being discharged into the atmosphere. Additionally, in one example the mercury and zinc provided by the venturi zinc scrubber 214 are configured to form a relatively stable zinc/mercury amalgam, e.g., responsive to a zinc powder being applied to the vaporized mercury. This solid-state mixture is entirely safe to handle and advantageously provides a manner in which mercury may be recovered from the carbon. Additionally, in one example the pH of the zinc/mercury amalgam is adjusted in order to better amalgamate the mercury with the zinc. Cementation of mercury in this manner is a feasible process to achieve a relatively high degree of mercury removal over a broad operational range within a relatively reasonable contact time.

Moreover, the carbon oxidizer 200 is also configured to operate in a very stable environment such that there are no leaks of mercury vapor out of the carbon oxidizer 200 and into the environment. Moreover, in one example the venturi zinc scrubber 214 operates at between 80-90 degrees Fahrenheit, preferably at 85 degrees Fahrenheit. At this temperature, mercury is forced to drop out of the gas stream, and can therefore be recovered in a safe and reliable manner. Also at this temperature, the air is forced through a pair of canisters 218 and 220 in order to ensure that zero mercury escapes to the atmosphere. The quality of the discharged air may be monitored before and after the discharge.

Continuing to refer to FIG. 1A, after the hot air passes through the venturi zinc scrubber 214 and the mercury is recovered, the hot air exits the venturi scrubber 214, passes through a fan 216 and into the pair of canisters 218 and 220 of the carbon oxidizer 200. The fan 216 of the carbon oxidizer 200 is preferably fluidly coupled to the venturi zinc scrubber 214, and the canisters 218 and 220 are preferably fluidly coupled to the fan 216 and configured to receive hot air from the venturi zinc scrubber 214 after the hot air has passed through the fan 216 in order to reduce a flow rate of the hot air. In other words, the canisters 218 and 220 are configured to slow the discharged air. Additionally, at least one of the canisters 218 and 220 contains a sulfur impregnated granular activated carbon filter, and the second canister 220 operates as a fail safe for the carbon oxidizer 200 in order to ensure that zero mercury escapes to the atmosphere. The carbon filters of the canisters 218 and 220 allow for a mercuric sulfide (e.g., a benign Cinnabar) to form with the sulfur contained in the activated carbon. With the carbon filters of the canisters 218 and 220 in place, zero mercury will escape the carbon oxidizer 200 into the environment. In one example embodiment, the carbon oxidizer 200 is configured to operate with only one canister 218, but may have the second canister 220 as a fail safe.

Accordingly, it will be appreciated that the disclosed concept provides for an improved (e.g., without limitation, better able to recover mercury) carbon oxidizer 200, in which, among other benefits, the carbon oxidizer 200 provides a clean process that recovers a solid-state zinc/mercury amalgam from the spent carbon without discharging vaporizing mercury to the environment.

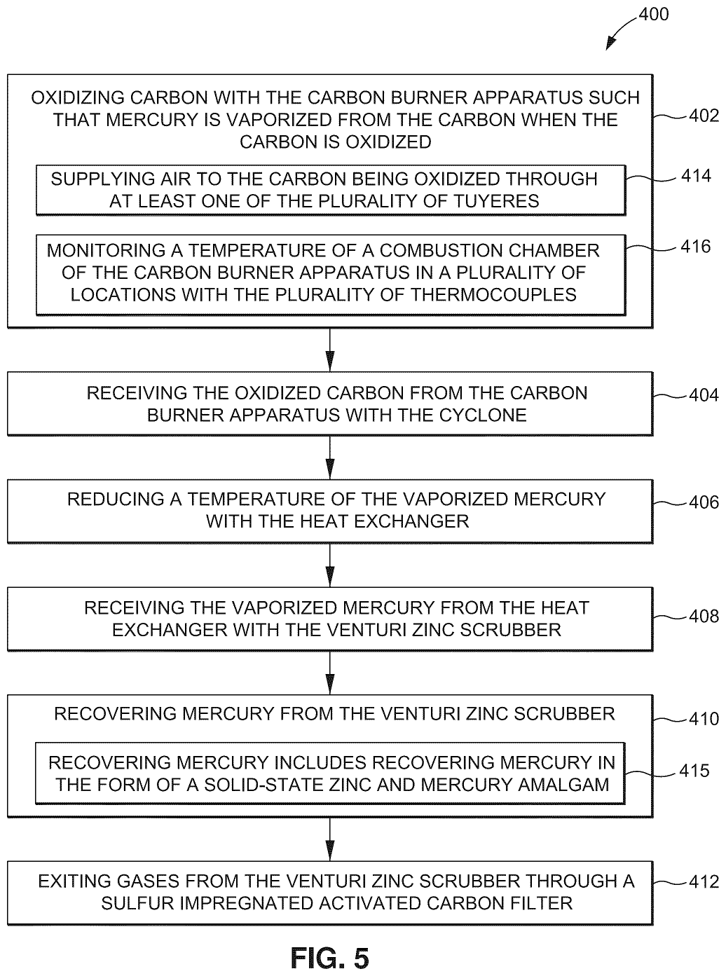

In another example, as shown in FIG. 5, a method 400 of recovering mercury with the carbon oxidizer 200 and 300 includes a step 402 of oxidizing carbon with the carbon burner apparatus 202 and 302 such that mercury is vaporized from the carbon when the carbon is oxidized, a step 404 of receiving the oxidized carbon from the carbon burner apparatus 202 and 302 with the cyclone 210 and 310, a step 406 of reducing a temperature of the vaporized mercury with the heat exchanger 212 and 312, a step 408 of receiving the vaporized mercury from the heat exchanger 212 and 312 with the venturi zinc scrubber 214 and 314, and a step 410 of recovering mercury from the venturi zinc scrubber 214 and 314. In one example, recovering mercury includes a step 415 of recovering mercury in the form of a solid-state zinc and mercury amalgam. The method may further include a step 412 of exiting gases from the venturi zinc scrubber 214 and 314 through a sulfur impregnated activated carbon filter. Furthermore, in one example, step 402 includes a step 414 of supplying air to the carbon being oxidized through at least one of the plurality of tuyeres 206, and/or a step 416 of monitoring a temperature of a combustion chamber of the carbon burner apparatus 202 in a plurality of locations with the plurality of thermocouples 203.

Additionally, the method may further include, responsive to a first thermocouple 203 of the plurality of thermocouples registering a first temperature at a first location of the combustion chamber defined by the bed plate 204 and the wall 207, increasing air flow through a first tuyere 206 of the plurality of tuyeres in order to adjust the first temperature, and responsive to a second thermocouple 203 of the plurality of thermocouples registering a second temperature at a second, different location of the combustion chamber defined by the bed plate 204 and the wall 207, decreasing air flow through a second tuyere 206 of the plurality of tuyeres in order to adjust the second temperature. Moreover, the method may also include reducing the temperature of the vaporized mercury with the heat exchanger 212 and 312 to less than 250 degrees Fahrenheit, and operating the venturi zinc scrubber 214 and 314 at a temperature of between 80-90 degrees Fahrenheit.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the methods described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A carbon oxidizer, comprising:
a carbon burner apparatus configured to oxidize carbon such that mercury is vaporized from the carbon when the carbon is oxidized;
a cyclone fluidly coupled to the carbon burner apparatus and configured to receive the oxidized carbon from the carbon burner apparatus;
a heat exchanger fluidly coupled to the cyclone and configured to reduce a temperature of the vaporized mercury; and
a venturi zinc scrubber fluidly coupled to the heat exchanger and configured to receive the vaporized mercury from the heat exchanger.

2. The carbon oxidizer according to claim 1, wherein the venturi zinc scrubber is configured to recover mercury in the form of a solid-state zinc and mercury amalgam.

3. The carbon oxidizer of claim 2, wherein the carbon burner apparatus comprises a bed plate and a plurality of nozzles coupled to the bed plate and configured to supply air to the carbon being oxidized.

4. The carbon oxidizer of claim 3, wherein the carbon burner apparatus further comprises a plurality of thermocouples coupled to a wall of the carbon burner apparatus, the wall being coupled to the bed plate and together with the bed plate defining a combustion chamber of the carbon burner apparatus, the plurality of thermocouples being configured for monitoring a temperature of air in the combustion chamber in a plurality of locations.

5. The carbon oxidizer of claim 4, wherein, responsive to a first thermocouple of the plurality of thermocouples registering a first temperature at a first location of the combustion chamber, air flow is increased through a first nozzle of the plurality of nozzles in order to adjust the first temperature, and wherein, responsive to a second thermocouple of the plurality of thermocouples registering a second temperature at a second, different location of the combustion chamber, air flow is decreased through a second nozzle of the plurality of nozzles in order to adjust the second temperature.

6. The carbon oxidizer of claim 4, wherein each of the thermocouples are submerged in the wall of the carbon burner apparatus.

7. The carbon oxidizer of claim 3, wherein the carbon burner apparatus further comprises an overflow chute coupled to the bed plate and configured to receive overflow carbon ash therethrough such that the overflow carbon ash exits the carbon oxidizer.

8. The carbon oxidizer of claim 2, further comprising a fan fluidly coupled to the venturi zinc scrubber and at least one canister fluidly coupled to the fan and configured to receive hot air from the venturi zinc scrubber after the hot air has passed through the fan in order to reduce a flow rate of the hot air.

9. The carbon oxidizer of claim 8, wherein the at least one canister comprises a first canister fluidly coupled to the fan and containing sulfur impregnated granular activate carbon, and a second canister fluidly coupled to the first canister and configured to ensure that mercury not recovered in the zinc and mercury amalgam does not escape to an atmosphere outside the carbon oxidizer.

10. The carbon oxidizer of claim 2, wherein the cyclone is configured to slow a velocity of the oxidized carbon and the vaporized mercury so that a precious metal ash comprising gold and silver separates from the vaporized mercury.

11. The carbon oxidizer of claim 2, wherein the heat exchanger is configured to reduce the temperature of the vaporized mercury to less than 250 degrees Fahrenheit, and wherein the venturi zinc scrubber is configured to operate at a temperature of between 80-90 degrees Fahrenheit.

12. The carbon oxidizer of claim 1, further comprising a second heat exchanger fluidly coupled to each of the carbon burner apparatus and the cyclone, a boiler fluidly coupled to the second heat exchanger, a steam generator fluidly coupled to the boiler, and a conduit fluidly coupled to the steam generator and configured to direct water from a water source into the steam generator, wherein the boiler is configured to be heated by gases passing from the carbon burner apparatus through the second heat exchanger and into the boiler, and wherein the boiler is configured to heat the water being directed into the steam generator from the water source in order to generate steam.

13. A carbon burner apparatus for a carbon oxidizer, the carbon burner apparatus comprising:
a bed plate configured to receive carbon thereon and heat the carbon such that carbon is oxidized in response, thereby releasing vaporized mercury;
a feed side wall coupled to the bed plate and configured to define a combustion chamber with at least the bed plate;
a plurality of nozzles coupled to the bed plate and configured to supply air to the carbon being oxidized;
a plurality of thermocouples coupled to the feed side wall for monitoring a temperature of the combustion chamber in a plurality of locations,
wherein, responsive to a first thermocouple of the plurality of thermocouples registering a first temperature at a first location of the combustion chamber, air flow is increased through a first nozzle of the plurality of nozzles in order to adjust the first temperature, and
wherein, responsive to a second thermocouple of the plurality of thermocouples registering a second temperature at a second, different location of the combustion chamber, air flow is decreased through a second nozzle of the plurality of nozzles in order to adjust the second temperature.

14. A method of recovering mercury with a carbon oxidizer, the carbon oxidizer comprising a carbon burner apparatus, a cyclone fluidly coupled to the carbon burner apparatus, a heat exchanger fluidly coupled to the cyclone, and a venturi zinc scrubber fluidly coupled to the heat exchanger, the method comprising:
oxidizing carbon with the carbon burner apparatus such that mercury is vaporized from the carbon when the carbon is oxidized;
receiving the oxidized carbon from the carbon burner apparatus with the cyclone;
reducing a temperature of the vaporized mercury with the heat exchanger;
receiving the vaporized mercury from the heat exchanger with the venturi zinc scrubber; and
recovering mercury from the venturi zinc scrubber.

15. The method of claim 14, wherein recovering mercury comprises recovering mercury in the form of a solid-state zinc and mercury amalgam.

16. The method of claim 15, further comprising exiting gases from the venturi zinc scrubber through a sulfur impregnated activated carbon filter.

17. The method of claim 14, wherein the carbon burner apparatus comprises a bed plate and a plurality of nozzles coupled to the bed plate, and wherein the method further comprises supplying air to the carbon being oxidized through at least one of the plurality of nozzles.

18. The method of claim 17, wherein the carbon burner apparatus further comprises a wall and a plurality of thermocouples coupled to the wall, wherein the wall is coupled to the bed plate and is configured to define a combustion chamber of the carbon burner apparatus with at least the bed plate, and wherein the method further comprises monitoring a temperature of the combustion chamber in a plurality of locations with the plurality of thermocouples.

19. The method of claim 18, further comprising:
responsive to a first thermocouple of the plurality of thermocouples registering a first temperature at a first location of the combustion chamber, increasing air flow through a first nozzle of the plurality of nozzles in order to adjust the first temperature; and
responsive to a second thermocouple of the plurality of thermocouples registering a second temperature at a second, different location of the combustion chamber, decreasing air flow through a second nozzle of the plurality of nozzles in order to adjust the second temperature.

20. The method of claim 14, further comprising:
reducing the temperature of the vaporized mercury with the heat exchanger to less than 250 degrees Fahrenheit; and
operating the venturi zinc scrubber at a temperature of between 80-90 degrees Fahrenheit.
